(19) United States
(12) Patent Application Publication
(10) Pub. No.: US 2009/0283375 A1
(43) Pub. Date: Nov. 19, 2009

(54) Automotive Drive Train Having a Six-Cylinder Engine

(76) Inventors: Mario Degler, Baden-Baden (DE); Stephan Maienschein, Baden-Baden (DE); Jan Loxtermann, Baden-Baden (DE); Thorsten Krause, Buehl (DE)

Correspondence Address: SIMPSON & SIMPSON, PLLC, 5555 MAIN STREET, WILLIAMSVILLE, NY, 14221-5406, US

(21) Appl. No.: 12/084,738

(22) PCT Filed: Oct. 12, 2006
(86) PCT No.: PCT/DE2006/001793

§ 371 Date: May 9, 2008

(30) Foreign Application Priority Data
Nov. 10, 2005 (DE) 102005053601.8

(51) Int. Cl. F16H 45/02; F16D 3/12

(52) U.S. Cl. 192/3.28

(57) ABSTRACT

An automotive drive train having an internal combustion engine that is configured as a six-cylinder engine and a hydrodynamic torque converter device. The device has a torsional vibration damper consisting of two energy accumulating devices and a converter lockup clutch. The turbine wheel is interposed between the two energy accumulating devices. The mass moment of inertia should be high between the two energy accumulating devices and masses should be as little as possible between the torsional vibration damper and the transmission input shaft.

### CROSS-REFERENCE TO RELATED APPLICATIONS

This application is the National Stage of PCT International Application No. PCT/DE2006/001793, filed Oct. 12, 2006, which application published in German and is hereby incorporated by reference in its entirety; said international application claims priority from German Patent Application No. 10 2005 053 601.8, filed Nov. 10, 2005 which is incorporated by reference in its entirety.

### FIELD OF THE INVENTION

The invention relates to an automotive drive train having a combustion engine configured as a six-cylinder engine, wherein the motor vehicle drive train comprises a torque converter device, comprising a torque converter lockup clutch, a torsion vibration damper, and a converter torus, formed by a pump shell, a turbine shell, and a stator shell, wherein the torsion vibration damper furthermore comprises a first energy accumulator means and a second energy accumulator means, and wherein between the first and second energy accumulator means, a first component is provided, which is connected in series with the first and second energy accumulator means, and wherein the turbine shell comprises an outer turbine dish, which is connected non-rotatably to the first component.

### BACKGROUND OF THE INVENTION

From German Patent No. DE 103 58 901 A1, a torque converter device is known, which comprises a converter lockup clutch, a torsion vibration damper, and a converter torus formed by a pump shell, a turbine shell and a stator shell, and wherein the torque converter device is obviously intended for a motor vehicle drive train. In the embodiments shown in FIGS. 1, 4 and 5 of German Patent No. DE 103 58 901 A1, a first component is apparently provided between a first and a second energy accumulator means of the torsion vibration damper, the first component is connected in series with the two energy accumulator means and connected non-rotatably to the outer turbine dish of the turbine shell.

### BRIEF SUMMARY OF THE INVENTION

It is the object of the invention to configure a motor vehicle drive train comprising a six-cylinder engine and a torque converter device, so it is well suited for motor vehicles with respect to its vibration properties, or torsion vibration properties, so that the motor vehicles provide convenient driving comfort.

Thus, a motor vehicle drive train is proposed, in particular, which comprises a six-cylinder engine or a combustion engine configured as six-cylinder engine. The combustion engine or the six-cylinder engine has a maximum engine torque M_{mot, max}. The motor vehicle drive train furthermore comprises an engine output shaft or a crank shaft and a transmission input shaft. Furthermore, the motor vehicle train comprises a torque converter device. The torque converter device comprises a converter housing, which is coupled to the engine output shaft, or to the crank shaft, preferably non-rotatably. Furthermore, the torque converter device comprises a converter lockup clutch, a torsion vibration damper and a converter torus formed by a pump shell, a turbine shell and a stator shell. The torsion vibration damper comprises a first energy accumulator means and a second energy accumulator means, connected in series with the first energy accumulator means. The first energy accumulator means comprises one or more first energy accumulators, or is formed by one or more first energy accumulators, and the second energy accumulator means comprises one or more second accumulators, or is formed by one or more second accumulators. Between the first and second energy accumulator means, a first component is provided, which is connected in series with the two energy accumulator means. This is done in particular, so that a torque can be transferred from the first energy accumulator means through the first component to the second energy accumulator means.

It is appreciated that a means, which is designated as “converter torus”, in this application is sometimes designated as “hydrodynamic torque converter”. The term “hydrodynamic torque converter”, however, is also partially used in prior applications for devices, which comprise a torsion vibration damper, a converter lockup clutch and a means formed by a pump shell, a turbine shell and a stator shell, or according to the language of the present disclosure a converter torus. With this background, the terms “hydrodynamic torque converter device” and “converter torus” are used in the present disclosure for reasons of clarity.

The turbine shell comprises an outer turbine dish, which is connected non-rotatably to the first component. Furthermore, the torque converter device comprises a third component, which is preferably connected non-rotatably to the transmission input shaft, which in particular abuts to the torque converter device. It can for example be provided, that the third component is directly coupled to the transmission input shaft, in particular coupled non-rotatably. However, it can also be provided that the third component is coupled to the transmission input shaft through one or several components connected in between, in particular coupled non-rotatably. The third component is connected in series to the second energy accumulator means and to the transmission input shaft, so that torque can be transferred from the second energy accumulator means through the third component to the transmission input shaft. The third component is thus disposed in particular between the second energy accumulator means and the transmission input shaft.

When transferring a torque through the first component, a change of the torque, which is transferred through the first component, is counteracted by a first mass moment of inertia. The first mass moment of inertia thus is also comprised in particular of the mass moment of inertia of the first component and of the mass moments of inertia of one or several possibly additional components, which are coupled to the first component, so that their respective mass moment of inertia also counteracts a change of the torque transfer through the first component, when transferring a torque through the first component. Such couplings can for example be non-rotatable couplings, in particular with reference to a rotation about the rotation axis of the torsion vibration damper. It is discussed supra, that the first mass moment of inertia during the transmission of a torque through the first component counteracts a change of the torque transferred through the first component. It is appreciated, that it is in particular also provided, that when no torque is transferred through the first component, the first mass moment of inertia counteracts the transfer of a torque through the first component. The first component preferably is a flange or a plate, wherein it is provided in particular, that the outer turbine dish and/or an inner turbine dish and/or blades or a blade assembly of the turbine shell or of the turbine is a component, or an assembly of several components, which is (are) coupled to the first component, so that its mass moment(s) of inertia add(s) to the first mass moment of inertia and thus in particular respectively as a summand of several summands.

When transferring a torque through the third component, a second mass moment of inertia counteracts a change of the torque transferred through the third component. The second mass moment of inertia thus is comprised in particular of the mass moment of inertia of the third component and the mass moments of inertia of one or several respective additional components, which are coupled to the third component, so that their respective mass moment of inertia counteracts the transfer of a torque through the third component when the torque transferred through the third component changes. Such couplings can for example be non-rotatable couplings, in particular with reference to a rotation about the rotation axis of the torsion vibration damper. It is discussed supra, that the second mass moment of inertia when transferring a torque through the third component counteracts a change of the torque transferred through the third component. It is appreciated that it is provided in particular, that when no torque is transferred through the third component, the second mass moment of inertia counteracts the transfer of a torque through the third component.

It is provided that the motor vehicle drive train, or the torque converter device, or the torsion vibration damper, or the first energy accumulator means is configured, so that the spring constant [in the units of Newton meter per degree (Nm/°)] of the first energy accumulator means is greater than or equal to the product of the maximum engine torque [in the units of Newton meter (Nm)] of the six-cylinder engine and the factor of 0.014 [in the units of per degree (1/°)] and less than or equal to the product of the maximum engine torque [in the units of Nm] of the six-cylinder engine and the factor 0.068 [in the units of 1/°]. Put into an equation, this means:

(M_{mot,max} [Nm]*0.014 [1/°])≦c₁≦(M_{mot,max} [Nm]*0.068 [1/°]),

wherein M_{mot,max} [Nm] is the maximum engine torque of the combustion engine or of the six-cylinder engine of the drive train in the units of “Newton times meter” (Nm), and wherein c₁ is the spring constant of the first energy accumulator means in the units of “Newton times meter divided by degrees” (Nm/°).

It is furthermore provided, that the motor vehicle drive train, or the torsion vibration damper or the second energy accumulator means is configured, so that the spring constant [in the units of Nm/°] of the second energy accumulator means is greater than or equal to the product of maximum engine torque [in the units of Nm] of the six-cylinder engine and the factor 0.035 [in the units of 1/°] and less than or equal to the product of the maximum engine torque [in the units of Nm] of the six-cylinder engine and the factor 0.158 [in the units of 1/°]. Put into an equation, this means:

(M_{mot,max} [Nm]*0.035 [1/°]) ≦c₂≦(M_{mot,max} [Nm]*0.158 [1/°]),

wherein M_{mot,max} [Nm] is the maximum engine torque of the combustion engine or of the six-cylinder engine of the drive train in the units of “Newton times meter” (Nm), and wherein c₂ is the spring constant of the second energy accumulator means in the units of “Newton times meter divided by degrees” (Nm/°).

It is furthermore provided, that the motor vehicle drive train or the torque converter device or the torsion vibration damper is configured, so that the quotient, which on the one hand is formed by the sum of the spring constant of the first energy accumulator means [in the units of Newton meter per radian (Nm/rad)], and the spring constant of the second energy accumulator means [in the units of Nm/rad] and, on the other hand, by the first mass moment of inertia [in the units of kilogram meter squared (kg*m²)], is greater than or equal to 17765 N*m/(rad*kg*m²), and less than or equal to 111033 N*m/(rad*kg*m²). Thus, put into an equation it is provided:

17765 N*m/(rad*kg*m²)≦(c₁+c₂)/J₁≦111033 N*m/(rad*kg*m²),

wherein c₁=spring constant of the first energy accumulator means [in the units of Nm/rad], and wherein c₂=spring constant of the second energy accumulator means [in the units of Nm/rad], and wherein J₁=first mass moment of inertia [in the units of kg*m²]. The abbreviation “rad” designates the radian measure.

It is furthermore provided that the motor vehicle drive train or the torque converter device or the torsion vibration damper or the transmission input shaft are configured, so that the quotient, which is on the one hand formed by the sum of the spring constant of the second energy accumulator means [in the units of Nm/rad] and the spring constant of the transmission input shaft [in the units of Nm/rad] and on the other hand of the second mass moment of inertia [in the units of kg*m²] is greater than or equal to 3158273 N*m/(rad*kg*m²) and less than or equal to 12633094 N*m/(rad*kg*m²). Thus, this reads as an equation:

3158273 N*m/(rad*kg*m²)≦(C₂+c_{GEW})/J₂≦12633094 N*m/(rad*kg*m²),

wherein c₂=spring constant of the second energy accumulator means [in the units of Nm/rad] and c_{GEW}=spring constant of the transmission input shaft [in the units of Nm/rad], and J₂=the second mass moment of inertia [in the units of kg*m²].

According to a preferred embodiment it is thus provided that the transmission input shaft is configured, so that the spring constant of the transmission input shaft is greater than or equal to 100 Nm/°, and less than or equal to 350 Nm/°. Thus, put into an equation the following applies preferably: 100 Nm/°≦c_{GEW}≦350 Nm/°, wherein c_{GEW}=spring constant of the transmission input shaft [in the units of Nm/°]. The following applies in particular: 120 Nm/°≦c_{GEW}≦300 Nm/°. According to another preferred embodiment the following applies: 120 Nm/°≦c_{GEW}≦210 Nm/°. According to another preferred embodiment the following applies: 130 Nm/°≦c_{GEW}≦150 Nm/°. It is preferred in particular, that the spring constant c_{GEW} of the transmission input shaft is approximately in a range of 140 N*m/° or is 140 N*m/°. These values of the spring constant c_{GEW} of the transmission input shaft relate in particular to a torsion loading or to a torsion loading about the central longitudinal axis of the transmission input shaft, or the spring constant c_{GEW} of the transmission input shaft is the spring constant of the transmission input shaft, which is effective or present or occurs under a torsion loading or under a torsion loading about the central longitudinal axis of the transmission input shaft. The transmission input shaft is supported rotatably and thus about its central longitudinal axis or rotation axis.

It is thus provided in particular that the torsion vibration damper is rotatable about a rotation axis of said torsion vibration damper. The rotation axis of the torsion vibration damper corresponds in an advantageous embodiment to the rotation axis of the transmission input shaft.

Preferably, a second component, which is for example configured as a plate or as a flange, is provided, which is connected in series with the first energy accumulator means and the first component. Thus, it is provided in particular, that the first energy accumulator means is disposed between the second component and the first component, so that a torque is transferrable from the second component through the first energy accumulator means to the first component. The second component is thus preferably provided between the converter lockup clutch and the first energy accumulator means, so that, when the converter lockup clutch is closed, a torque transferred through the converter lockup clutch can be transferred through the second component to the first energy accumulator means. The converter lockup clutch can be connected to the converter housing non-rotatably, or in a solid manner, so that when the converter lockup clutch is closed, a torque from the converter housing can be transferred through the converter lockup clutch. The converter lockup clutch can for example be configured as multidisc clutch. Thus, it can for example comprise a press component or an axially movable and hydraulically loadable piston, by means of which the multidisc clutch can be closed. Thus it can for example be provided that the second component is the press component or the piston of the multidisc clutch or connected non-rotatably to the press component or the piston.

The first component is a plate or a flange in a preferred embodiment. The third component is a plate or a flange in a preferred embodiment. The third component can form for example a hub or it can be coupled non-rotatably to a hub. This hub can for example be coupled non-rotatably to the transmission input shaft, or it can engage non-rotatably with the transmission input shaft.

It is preferably provided that the second component or a component connected non-rotatably therewith forms an input component of the first energy accumulator means. It can be provided in particular, that the second component or a component coupled non-rotatably therewith, engages in particular on the input side with the first energy accumulators of the first energy accumulator means or engages with first face sides of the first energy accumulator means. It is provided in particular, that the first component or a component connected non-rotatably to said first component, and thus in particular on the output side, engages with the first energy accumulators of the first energy accumulator means, or with second front faces, which are different from the first front faces, of the first energy accumulators of the first energy accumulator means. It is furthermore provided in particular that the first component, or possibly an additional component, connected non-rotatably with the first component and in particular on the input side engages with the second energy accumulator of the second energy accumulator means, or with the first front faces of the second energy accumulators of the second energy accumulator means. Furthermore it is provided in particular that the third component or a component connected non-rotatably with the third component and in particular on the output side engages with the second energy accumulators of the second energy accumulator means, or engages with second front faces, which are different from the first front faces of the second energy accumulator means.

According to a preferred embodiment, the first energy accumulator means comprises several first energy accumulators or is comprised of several first energy accumulators. The first energy accumulators are coil springs or arc springs according to a preferred embodiment. It can be provided that all of the first energy accumulators are connected in parallel. According to an improved embodiment, the or all first energy accumulators are disposed distributed, or offset, about the circumference with reference to the circumferential direction of the rotation axis of the torsion vibration damper. However, it can also be provided that several first energy accumulators are disposed distributed, or offset, about the circumference with reference to the circumferential direction of the rotation axis of the torsion vibration damper, wherein the energy accumulators, which are disposed distributed, or offset, about the circumference are configured as arc springs or as coil springs, and receive respectively one or several additional first energy accumulators in their interior. In an embodiment of the latter type, it can be provided that when loading the first energy accumulator means, gradually increasing the load from the unloaded state, initially only those first energy accumulators store energy, which receive one or several first energy accumulators in their interior and which store energy in the first energy accumulator, received in the interior, when the load on the first energy accumulator means is above a predetermined threshold load, or above a predetermined threshold torque, or vice versa.

According to a preferred embodiment, the second energy accumulator means comprises several second energy accumulators, or it is comprised of several second energy accumulators. The second energy accumulators according to a preferred embodiment are coil springs or compression springs or straight springs. It can be provided that all the second energy accumulators are connected in parallel. According to an improved embodiment, the or all second energy accumulators are disposed distributed, or offset, about the circumference with reference to the circumferential direction of the rotation axis of the torsion vibration damper. However, it can also be provided that several second energy accumulators are disposed distributed, or offset, about the circumference with reference to the circumferential direction of the rotation axis of the torsion vibration damper, wherein the second energy accumulators which are disposed distributed, or offset, about the circumference are provided as compression springs or as straight springs or as coil springs and receive one or several additional second energy accumulators in their interior. In an embodiment of the latter type, it can be provided that under a loading, which gradually increases from the unloaded state of the second energy accumulator means, initially only those second energy accumulators accumulate energy, which receive one or several additional second energy accumulators in their interior, and the second energy accumulator received in the interior only store energy, when the loading of the second energy accumulator means is above a predetermined threshold loading or above a predetermined threshold torque or vice versa.

Preferably, the first energy accumulators are disposed, or the first energy accumulator means is disposed radially outside of the second energy accumulators or of the second energy accumulator means. This relates in particular to the radial direction of the rotation axis of the torsion vibration damper.

The spring constant of the first energy accumulator means is in particular the spring constant, or the combined spring constant, which is effective or given or occurs at torque loads of the first energy accumulator means and thus in particular under torque loads, which act about the rotation axis of the torsion vibration damper upon the first energy accumulator means. The spring constant of the first energy accumulator means is determined in particular by the spring constants of the first energy accumulators and their disposition and their connection. The spring constant of the first energy accumulator means is thus in particular a combined spring constant, which is determined by the spring constants of the first energy accumulators and their arrangement or their connection. As discussed, the first energy accumulators are connected in parallel in a preferred embodiment. However, it can also be provided for example that the first energy accumulators are connected, so that they basically form a parallel assembly, wherein first energy accumulators are connected in series in the parallel paths of this parallel assembly thus formed.

The spring constant of the second energy accumulator means is in particular the spring constant or the combined spring constant, which is effective or given or occurs under torque loadings of the second energy accumulator means, and thus in particular under torque loadings, which impact the second energy accumulator means about the rotation axis of the torsion vibration damper. The spring constant of the second energy accumulator means is determined in particular by the spring constants of the second energy accumulators and their disposition or connection. The spring constant of the second energy accumulator means is thus in particular a combined spring constant, which is defined by the spring constants of the second energy accumulators and their disposition or their connection. As described, the second energy accumulators are connected in parallel in an advantageous embodiment. However, it can also be provided, for example, that second energy accumulators are connected, so that they basically form a parallel connection, wherein second energy accumulators are connected in series in the parallel paths of the parallel assembly.

The first mass moment of inertia particularly relates to the rotation axis of the torsion vibration damper. The first component is for example a plate. It can be provided that the outer turbine dish is connected non-rotatably to the first component by means of one or more driver components. Thus, it is provided in particular that the mass moment of inertia of such driver component(s) determine(s) or co-determine(s) the first mass moment of inertia and thus in particular as a summand. It is provided in particular that the mass moments of inertia of the components, in particular of the first component, or of the component, through which a torque is transferred from the first energy accumulators of the first energy accumulator means to the to the second energy accumulators of the second energy accumulator means, or which are connected between the first energy accumulators of the first energy accumulator means and the second energy accumulators of the second energy accumulator means determine or co-determine the first mass moment of inertia. The mass moments of inertia respectively relate in particular to the rotation axis of the torsion vibration damper.

The second mass moment of inertia relates to the rotation axis of the torsion vibration damper in particular. The third component is for example a plate.

Preferably the motor vehicle drive train or the torque converter device or the torsion vibration damper or the first energy accumulator means are configured so that the following applies:

(M_{mot,max} [Nm]*0.02 [1/°])≦c₁≦(M_{mot,max} [Nm]*0.06 [1/°]); or the following applies:

(M_{mot,max} [Nm]*0.03 [1/°])≦c₁≦(M_{mot,max} [Nm]*0.05 [1/°]).

Preferably the motor vehicle drive train or the torque converter device or the torsion vibration damper or the second energy accumulator means are configured so that the following applies:

(M_{mot,max} [Nm]*0.04 [1/°])≦c₂≦(M_{mot,max} [Nm]*0.15 [1/°]); or the following applies:

(M_{mot,max} [Nm]*0.05 [1/°])≦c₂≦(M_{mot,max} [Nm]*0.13 [1/°]); or the following applies:

(M_{mot,max} [Nm]*0.06 [1/°])≦c₂≦(M_{mot,max} [Nm]*0.1 [1/°]).

Preferably the motor vehicle drive train or the torque converter device or the torsion vibration damper is configured, so that the following applies:

25000 N*m/(rad*kg*m²)≦(c₁+c₂)/J₁≦105000 N*m/(rad*kg*m²); or so that the following applies:

35000 N*m/(rad*kg*m²)≦(c₁+c₂)/J₁≦95000 N*m/(rad*kg*m²); or so that the following applies:

40000 N*m/(rad*kg*m²)≦(c₁+c₂)/J₁≦90000 N*m/(rad*kg*M²).

Preferably the motor vehicle drive train or the converter device or the torsion vibration damper or the transmission input shaft are configured, so that the following applies:

3500000 N*m/(rad*kg*m²)≦(c₂+c_{GEW})/J₂≦12000000 N*m/(rad*kg*m²); or so that the following applies:

4000000 N*m/(rad*kg*m²)≦(c₂+c_{GEW})/J₂≦11000000 N*m/(rad*kg*m²); or so that the following applies:

4500000 N*m/(rad*kg*m²)≦(c₂+c_{GEW})/J₂≦10500000 N*m/(rad*kg*m²); or so that the following applies:

5000000 N*m/(rad*kg*m²)≦(c₂+c_{GEW})/J₂≦10000000 N*m/(rad*kg*m²).

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic view of an exemplary motor vehicle drive train;

FIG. 2 is a section of an exemplary motor vehicle drive train according to the invention, comprising a first exemplary hydrodynamic torque converter device;

FIG. 3 is a section of an exemplary motor vehicle drive train according to the invention comprising a second exemplary hydrodynamic torque converter device;

FIG. 4 is a section of an exemplary motor vehicle drive train comprising a third hydrodynamic torque converter device; and,

FIG. 5 is a spring rotating mass schematic of a section of an exemplary motor vehicle drive train for the case of the closed converter lockup clutch.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

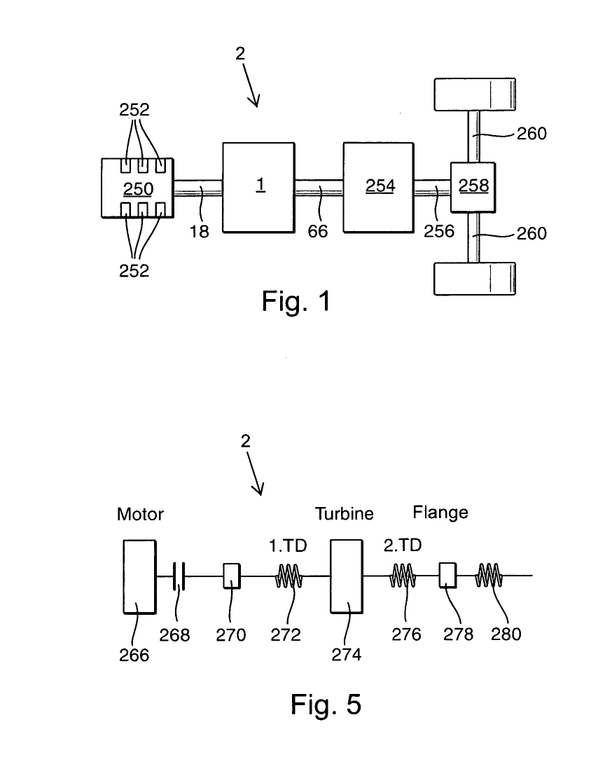

FIG. 1 shows an exemplary motor vehicle drive train 2 according to the invention in a schematic illustration. Motor vehicle drive train 2 comprises combustion engine 250 and drive shaft or engine output shaft or crank shaft 18, which can be driven by combustion engine 250 in a rotating manner. Combustion engine 250 comprises exactly six cylinders 252, or it is six-cylinder engine 250. Six-cylinder engine 250 comprises a maximum engine torque M_{mot,max}, or it can impart a maximum torque into drive train 2, which corresponds to the maximum engine torque M_{mot,max}.

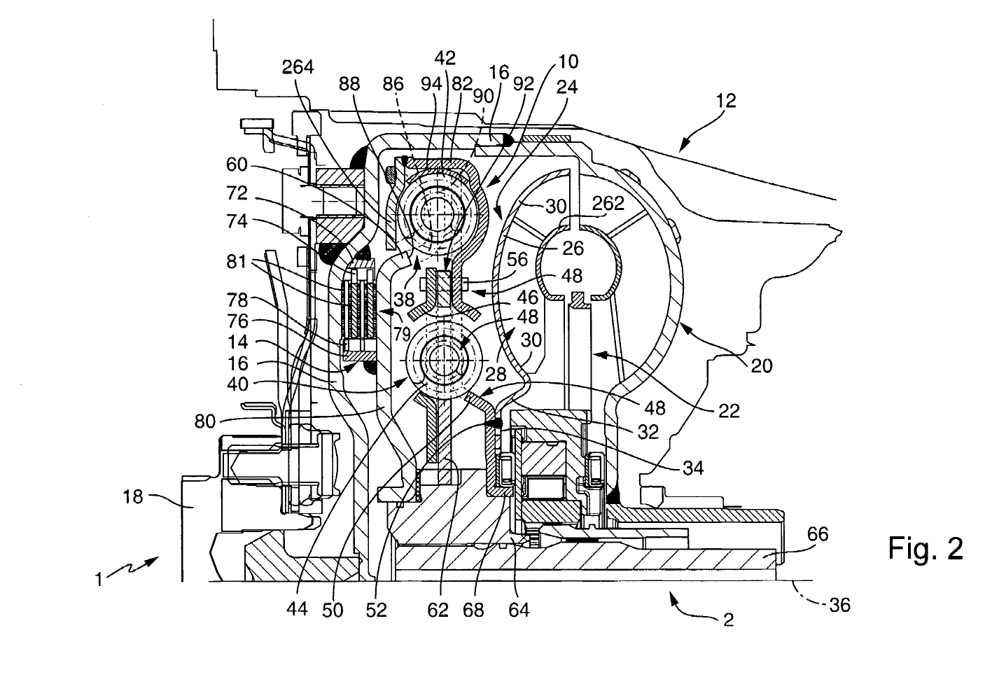

Motor vehicle drive train 2 comprises hydrodynamic torque converter device 1, which is configured according to one of the embodiments, which are described with reference to FIGS. 2 through 4.

Motor vehicle drive train 2 furthermore comprises transmission 254, which is for example an automatic transmission. Furthermore, motor vehicle drive train 2 can comprise transmission output shaft 256, differential 258 and one or several drive axles 260. Motor vehicle drive train 2 furthermore comprises transmission input shaft 66 between torque converter device 1 and transmission 254. Torque converter device 1, or a component like hub 64 of torque converter device 1 is connected non-rotatably to transmission input shaft 66. Engine output shaft or crank shaft 18 is coupled non-rotatably to converter housing 16 of torque converter device 1. Thus a torque can be transferred from drive shaft or engine output shaft or crank shaft 18 through torque converter device 1 to transmission input shaft 66.

FIGS. 2 through 4 show various exemplary hydrodynamic torque converter devices 1, which can be provided in an exemplary motor vehicle drive train 2 according to the invention, or in motor vehicle drive train 2, shown in FIG. 1.

The embodiments illustrated in FIGS. 2 through 4 are components of an exemplary motor vehicle drive train 2 according to the invention, which comprises six-cylinder engine 250, which is not shown in FIGS. 2 through 4, or combustion engine 250, which is not shown in FIGS. 2 through 4, which is configured as a six-cylinder engine and thus comprises three cylinders 252. Hydrodynamic torque converter device 1 comprises torsion vibration damper 10 and converter torus 12 formed by pump shell 20, turbine shell 24 and stator shell 22, and comprises converter lockup clutch 14.

Torsion vibration damper 10, converter torus 12, and converter lockup clutch 14 are received in converter housing 16. Converter housing 16 is connected substantially non-rotatably to drive shaft 18, which is in particular the crank shaft or the engine output shaft of a combustion engine.

As discussed, converter torus 12 comprises pump or pump shell 20, stator shell 22 and turbine or turbine shell 24, which interact in a known manner. In a known manner, converter torus 12 comprises converter torus cavity or torus interior 28, which is provided for receiving oil or for an oil flow. Turbine shell 24 comprises outer turbine dish 26, which forms wall section 30, which directly abuts to torus interior 28 and which is provided for defining torus interior 28. Furthermore, turbine shell 24 comprises inner turbine dish 262 and turbine blades in a known manner. Extension 32 of outer turbine dish 26 connects to wall section 30 directly abutting to torus interior 28. Extension 32 comprises straight or annular section 34. Straight or annular section 34 of extension 32 can for example be configured, so that it is substantially straight in a radial direction of rotation axis 36 of torsion vibration damper 10, and disposed in particular as an annular section in a plane disposed perpendicular to rotation axis 36, or so that it defines said plane.

Torsion vibration damper 10 comprises first energy accumulator means 38 and second energy accumulator means 40. First energy accumulator means 38 and second energy accumulator means 40 are spring means in particular.

In the embodiments shown in FIGS. 2 through 4, it is provided that first energy accumulator means 38 comprises several first energy accumulators 42, or that it is comprised of the energy accumulators, for example, coil springs or arc springs, offset from one another in a circumferential direction extending about rotation axis 36. It can be provided that all first energy accumulators 42 are configured identically. It can also be provided that differently configured first energy accumulators 42 are provided.

The spring constant c₁ [in the units of Nm/°] of first energy accumulator means 38 is greater than or equal to the product of the maximum engine torque M_{mot,max} [in the units of Nm] of six-cylinder engine 250 and the factor 0.014 [in the units of 1/°] and less than or equal to the product of the maximum engine torque [in the units of Nm] of six-cylinder engine 250 and the factor 0.068 [in the units of 1/°]. Thus, the following applies:

(M_{mot,max} [Nm]*0.014 [1/°])≦c₁≦(M_{mot,max} [Nm]*0.068 [1/°]), wherein M_{mot,max} [Nm] is the maximum engine torque of the combustion engine or of six-cylinder engine 250 of drive train 2 in the units of “Newton times meter” (Nm), and wherein c₁ is the spring constant of first energy accumulator means 38 in the units of “Newton meter divided by degrees” (Nm/°). The values or ranges however can be also disposed as described supra and infra.

Second energy accumulator means 40 comprises plural second energy accumulators 44, respectively configured as coil springs or compression springs or straight springs, or it is formed by second energy accumulators 44. Thus, in a preferred embodiment, several second energy accumulators 44 are disposed offset from one another relative to the circumferential direction of the rotation axis. It can be provided that second energy accumulators 44 are respectively configured identical. Different second energy accumulators 44 however can also be configured differently.

The spring constant c₂ [in the units of Nm/°] of second energy accumulator means 40 is greater than or equal to the product of the maximum engine torque M_{mot,max} [in the units of Nm] of six-cylinder engine 250 and the factor 0.035 [in the units of 1/°] and less than or equal to the product of the maximum engine torque M_{mot,max} [in the units of Nm] of six-cylinder engine 250 and the factor 0.158 [in the units of 1/°]. Thus, the following applies:

(M_{mot,max} [Nm]*0.035 [1/°])≦c₂≦(M_{mot,max} [Nm]*0.158 [1/°]), wherein M_{mot,max} [Nm] is the maximum engine torque of the combustion engine or six-cylinder engine 250 of drive train 2 in the units of “Newton times meter” (Nm), and wherein c₂ is the spring constant of the second energy accumulator means in the units of “Newton times meter divided by degrees” (Nm/°). The values or ranges however can be also disposed as described supra and infra.

According to the embodiments shown in FIGS. 2 through 4, second energy accumulator means 40 is disposed with reference to the radial direction of rotation axis 36 radially within first energy accumulator means 38. First energy accumulator means 38 and second energy accumulator means 40 are connected in series. Torsion vibration damper 10 comprises first component 46, which is disposed between first energy accumulator means 38 and second energy accumulator means 40, or connected in series with energy accumulator means 38 and 40. It is also provided in particular for example when lockup clutch 14 is closed, that a torque can be transferred from first energy accumulator means 38 through first component 46 to second energy accumulator means 40. First component 46 can also be designated as intermediary component 46, which is also done infra.

It is provided in the embodiments shown in FIGS. 2 through 4, that outer turbine dish 26 is connected to intermediary component 46, so that a load, in particular torque and/or force, can be transferred from outer turbine dish 26 to intermediary component 46.

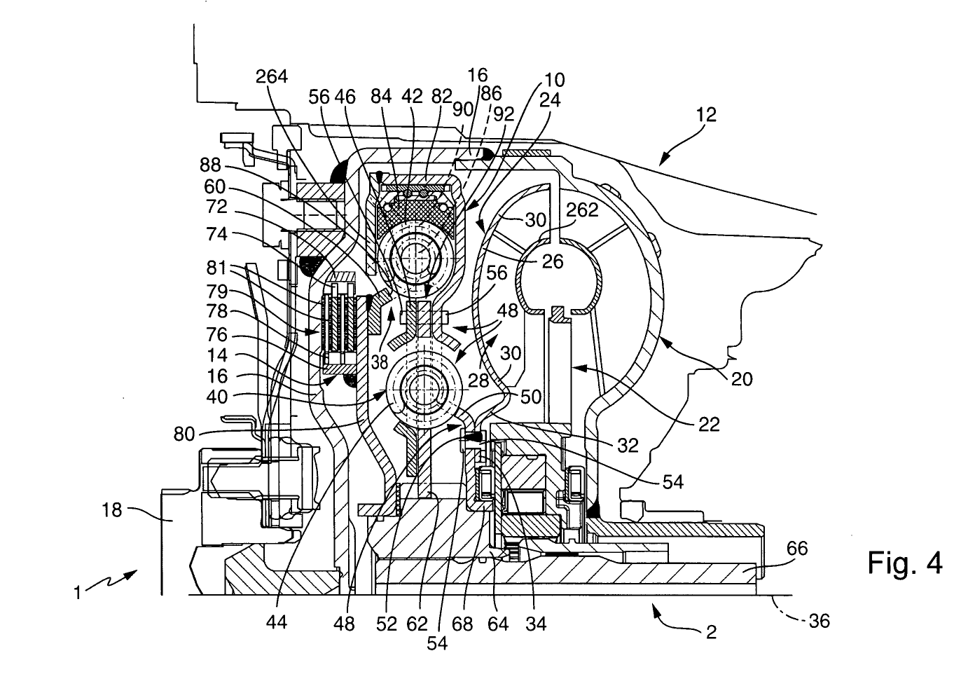

Between outer turbine dish 26 and intermediary component 46, or in the load flow, in particular in the torque or force flow between outer turbine dish 26 and intermediary component 46, driver component 50 is provided. It can also be provided that extension 32 also forms intermediary component 46 and/or driver component 50, or takes over their function. It can also be provided that driver component 50 forms a first component or an intermediary component, which is connected in series in the torque flow between energy accumulator means 38 and 40. It is furthermore provided that along load transfer path 48, through which a load or a torque can be transferred from outer turbine dish 26 to intermediary component 46, at least one connection means 52, 56 or 54 is provided. Such a connection means 52, 56, or 54 can for example be a plug-in connection or a rivet connection, or a bolt connection (see reference numeral 56 in FIGS. 2 through 4) or a weld (see reference numeral 52 in FIGS. 2 through 4) or similar structure. It is appreciated that in FIG. 4 at the location, where weld 52 is provided, an additional rivet or bolt connection 52 is drawn, in order to show an alternative configuration. This is also intended to clarify that the connection means can also be configured differently or can be combined differently. By respective connection means 52, 54, and 56, respective adjoining components of load transfer path 48, through which the load can be transferred from outer turbine dish 26 to intermediary component 46, are coupled amongst one another. Thus, extension 32 of outer turbine dish 26 is coupled in the embodiments shown in FIGS. 2 through 4 with driver component 50 respectively non-rotatable by connection means 52 configured as a weld (which can also alternatively be a rivet or bolt connection according to FIG. 4) and driver component 50 is coupled torque proof to intermediary component 46 through connection means 56, respectively configured as a rivet or bolt connection.

It is provided that all connection means 52, 54 and 56, by which components adjoining along load transfer path 48 between outer turbine dish 26 and intermediary component 46, for example, extension 32 and driver component 50 or driver component 50 and intermediary component 46, are connected, are offset from wall section 30 of outer turbine dish 26 directly adjoining to torus interior 28. This facilitates at least according to the embodiments, that the bandwidth of possible connection means is increased. Thus it is possible for example that not only thin plate- or MAG- or Laser- or dot welding is used as welding method, but also for example friction welding.

Second component 60 and third component 62 are connected in series with first energy accumulator means 38, second energy accumulator means 40 and intermediary component 46 provided between two energy accumulator means 38 and 40. Second component 60 forms an input component of first energy accumulator means 38 and third component 62 forms an output component of second energy accumulator means 40. A load or a torque transferred by second component 60 into first energy accumulator means 38 can thus be transferred on the output side of first energy accumulator means 38 through intermediary component 46 and second energy accumulator means 40 to third component 62.

Third component 62 engages hub 64, forming a non-rotatable connection, which is in turn coupled non-rotatably to output shaft 66 of torque converter device 1, which is for example transmission input shaft 66 of a motor vehicle transmission. Alternatively it can however also be provided that third component 62 forms hub 64. Outer turbine dish 26 is radially supported at hub 64 by means of support section 68. Support section 68, which is in particular radially supported at hub 64, is substantially configured sleeve shaped.

It is appreciated that the radial support of outer turbine dish 26 by means of support section 68 is configured, so that support forces acting upon outer turbine dish 26 through the radial support are not conducted through first or second energy accumulator means 38 and 40, respectively, from support section 68 to outer turbine dish 26. Support section 68 is rotatable relative to hub 64. It can be provided, that a straight bearing or a straight bearing bushing, or a roller bearing, or similar is provided for radial support between hub 64 and support section 68. Furthermore, respective bearings can be provided for axial support. The connection already discussed supra between outer turbine dish 26 and intermediary component 46 is configured, so that a torque, which is transferrable from outer turbine dish 26 to intermediary component 46, can be transferred without one of energy accumulator means 38 or 40 being provided along the respective load transfer path 48. The torque transfer from outer turbine dish 26 to intermediary component 46 through load transfer path 48 can thus be provided in particular by means of a substantially rigid connection.

In the embodiments shown in FIGS. 2 through 4, two respective connection means are provided along load or force or torque transfer path 48 between outer turbine dish 26 and intermediary component 46, and thus first connection means 52 or 54 and second connection means 56. It is appreciated that with reference to the circumferential direction of rotation axis 36, distributed in circumferential direction, several distributed first connection means 52 or second connection means 56 can be provided or can preferably be provided. First connection means 52 or 54 (subsequently “first connection means 52” is referred to for purposes of simplification) connect non-rotatably extension 32 to driver component 50 and second connection mean(s) 56 (subsequently referred to as second connection means 54 for purposes of simplification) connect non-rotatably driver component 50 to intermediary component 46.

As illustrated in FIGS. 2 through 4, sleeve shaped support portion 68 can for example be a radially inner section of driver component 50 with reference to the radial direction of rotation axis 36.

Converter lockup clutch 14 is provided in the embodiments shown in FIGS. 2 through 4 as a respective multidisc clutch and comprises first disk carrier 72, by which first disks 74 are received non-rotatably, and second disk carrier 76 by which second disks 78 are received non-rotatably. When multidisc clutch 14 is open, first disk carrier 72 is movable relative to second disk carrier 76 and thus so that first disk carrier 72 is rotatable relative to second disk carrier 76. Second disk carrier 76 is disposed with reference to the radial direction of axis 36 radially within first disk carrier 72, however, also the opposite can be the case. First disk carrier 72 is connected to converter housing 16. For actuation, multidisc clutch 14 comprises piston 80, which is disposed axially movable and which can be loaded for example hydraulically for actuating multidisc clutch 14. Piston 80 is connected in a rigid manner or non-rotatably to second disk carrier 76, which can be effectuated for example by means of a welded connection. First disks 74 and second disks 78 alternate viewed in the longitudinal direction of rotation axis 36. When loading disk packet 79 formed by first disks 74 and second disks 78, by means of piston 80, disk packet 79 is supported on the side of disk packet 79 opposite to piston 80 at a section of the inside of converter housing 16. Between adjacent disks 74 and 78 and at both ends of disk packet 79, friction liners 81 are provided, which are for example held at disks 74 and/or 78. Friction liners 81 which are provided at the ends of disk packet 79, can also be supported on the one side and/or the other side also at the inside of converter housing 16 or at piston 80.

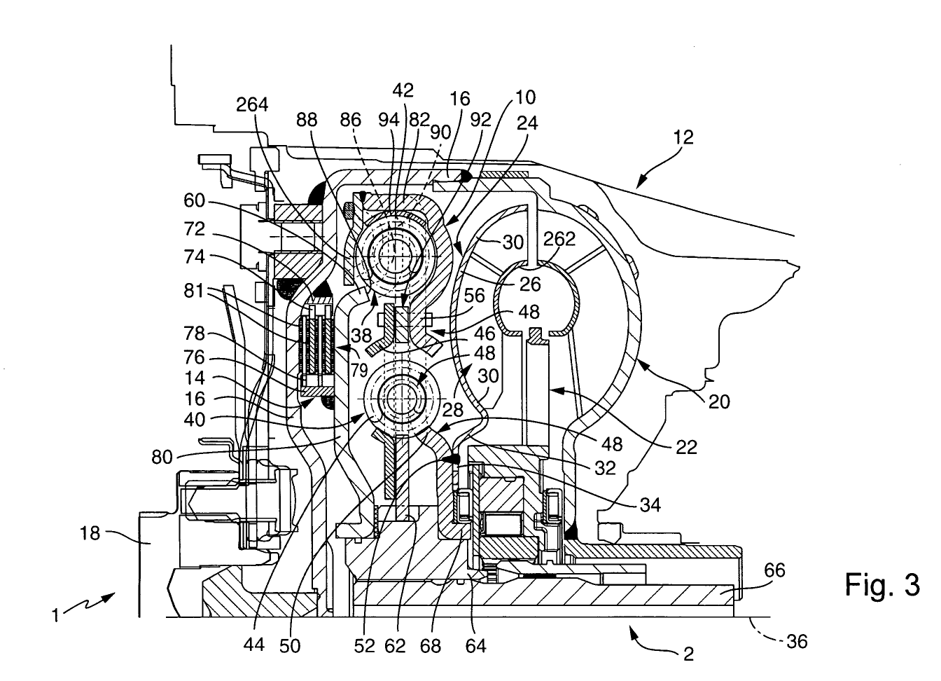

In the embodiments shown in FIGS. 2 and 3, piston 80 is integrally formed with second component 60, thus the input component of first energy accumulator means 38. In the embodiment shown in FIG. 4, piston 80 is connected non-rotatably or fixated to second component 60 or the input component of first energy accumulator means 38, wherein the fixation is performed is here for example by a weld. As a matter of principle a non-rotatable connection can also be performed in another manner. In the embodiments shown in FIGS. 2 and 3, in an alternative embodiment, piston 80 and input component 60 of first energy accumulator means 38 can also be provided as separate components connected amongst one another in a fixated or non-rotatable manner for example by a weld or a rivet or a bolt. In the embodiment shown in FIG. 4, also another suitable connection can be provided between piston 80 and input component 60 instead of a weld, in order to generate the solid or non-rotatable connection, for example, a bolt or rivet joint or a plug-in connection or alternatively, piston 80 with input component 60 can also be manufactured integrally from one piece.

Piston 80 or second component 60, the first component, or intermediary component 46, driver component 50 and third component 62 are respectively formed by plates. Second component 60 is a flange in particular. First component 46 is a flange in particular. Third component 62 is a flange in particular.

In the embodiment shown in FIG. 3, the plate thickness of driver component 50 is greater than the plate thickness of piston 80, or of input component 60 of first energy accumulator means 38. Furthermore it can be provided in the embodiments shown in FIGS. 2 through 4, that the mass moment of inertia of driver component 50 is greater than the mass moment of inertia of piston 80 or of input component 60 or of the unit made of components 60 and 80.

For first energy accumulators 42, a respective type of housing 82 is formed, which extends with reference to the radial direction and to the axial direction of rotation axis 36 at least partially on both sides axially and radially on the outside about first energy accumulator 42. In the embodiments shown in FIGS. 2 through 4, the housing is disposed at driver component 50. In most embodiments the non-rotatable disposition at driver component 50 or at the outer turbine dish is more advantageous from a vibration point of view, than for example a torque proof disposition at second component 60. Housing 82 in this case comprises cover 264, which is for example welded on.

In the embodiment shown in FIG. 4, first energy accumulators 42 can be supported at housing 82 for friction reduction by a respective means 84 comprising roller bodies like balls or rollers, which can also be designated as a roller shoe. Though this is not shown in FIGS. 2 and 3, such a device 84, comprising roller bodies like balls or rollers for supporting first energy accumulators 42 or for friction reduction can also be accordingly provided in the embodiments shown in FIGS. 2 and 3. According to FIGS. 2 and 3, however, slider dish or slider shoe 94 is provided here instead of roller shoe 84 for the low friction support of first energy accumulators 42.

Furthermore, second rotation angle limiter means 92 is provided for second energy accumulator means 40 in the embodiments shown in FIGS. 2 through 4, by which the maximum rotation angle or the relative rotation angle of second energy accumulator means 40 or of the input component of second energy accumulator means 40 relative to the output component of second energy accumulator means 40 is limited. This is performed here, so that the maximum rotation angle of second energy accumulator means 40 is limited by second rotation angle limiter means 92, so that it is avoided that second energy accumulators 44, which are springs in particular, go into blockage under a respectively high torque loading. Second rotation angle limiter means 92 is configured as shown in FIGS. 2 through 4 for example, so that driver component 50 and intermediary component 46 are connected non-rotatably by a bolt, which is in particular a component of connection means 56, wherein the bolt extends through a slotted hole, which is provided in the output component of second energy accumulator means 40 or in third component 62. A first rotation angle limiter means can also be provided for first energy accumulator means 38, which is not shown in the figures, by which the maximum rotation angle of first energy accumulator means 38 is limited, so that a blockage loading of first energy accumulators 42, which are in particular provided as respective springs, is avoided. In particular when, which is advantageously the case, second energy accumulators 44 are straight compression springs and first energy accumulators 42 are arc springs, it can be provided as illustrated in FIGS. 2 through 4 that only a second rotation angle limiter means is provided for second energy accumulator means 40, since in such configurations in case of a blockage loading the risk of damaging the arc springs is lower than in case of straight springs and an additional first rotation angle limiter means will increase the number of components or the manufacturing cost.

In a particularly advantageous embodiment, it is provided in the configurations shown in FIGS. 2 through 4, that the rotation angle of first energy accumulator means 38 is limited to a maximum first rotation angle and the rotation angle of second energy accumulator means 40 is limited to a maximum second rotation angle, wherein first energy accumulator means 38 reaches its maximum first rotation angle, when a first threshold torque is applied to first energy accumulator means 38, and wherein second energy accumulator means 40 reaches its second maximum rotation angle, when a second threshold torque is applied to second energy accumulator means 40, wherein the first threshold torque is less than the second threshold torque. This can be performed in particular by a respective setting of the two energy accumulator means 38 and 40 or of energy accumulators 42 and 44 of the two energy accumulator means 38 and 40, respectively, possibly or in particular also by the first and/or second rotation angle limiter means. It can be provided that first energy accumulators 42 go into blockage under the first threshold torque, so that first energy accumulator means 38 reaches its maximum first rotation angle, and it is caused by a second rotation angle limiter means for second energy accumulator means 40, that second energy accumulator means 40 reaches its maximum second rotation angle at a second threshold torque, wherein the maximum second rotation angle is reached, when the second rotation angle limiter means reaches a stop position.

This way, a particularly good setting for partial load operations can be reached.

It is appreciated that the rotation angle of first energy accumulator means 38 or of second energy accumulator means 40, and this applies accordingly to the maximum first or maximum second rotation angle, are thus the relative rotation angle with reference to rotation axis 36 of torsion vibration damper 10, which is given relative to the unloaded resting position between components adjoining one another on the input side and on the output side for a torque transfer respectively directly to the respective components adjoining energy accumulator means 38 or 40. The rotation angle, which is limited in particular in said manner by the respective maximum first or second rotation angle, can change in particular by energy accumulator 42 or 44 of the respective energy accumulator means 38 or 40 absorbing energy or releasing stored energy.

In converter torus 12 and also outside of converter torus 12 within converter housing 16, oil is included in particular.

In the embodiments shown in FIGS. 2 through 4, piston 80, or the second component, or input component 60 of first energy accumulator means 38 form several lugs 86, distributed about the circumference, each comprising non-free end 88 and free end 90, and which are provided for a face side, input side loading of the respective first energy accumulator 42. Non-free end 88 is thus disposed with reference to the radial direction of rotation axis 36 radially within free end 90 of the respective lug 86.

As shown in FIGS. 2 through 4, the radial extension of driver component 50 can be greater than the center radial distance of first energy accumulator(s) 42 from second energy accumulator(s) 44.

In the embodiments shown in FIGS. 2 through 4, it is respectively provided that transmission input shaft 66 is configured, so that the spring constant c_{GEW} of transmission input shaft 66 is in the range of 100 Nm/° to 350 Nm/°. The value ranges can however also be selected, as it is described supra and infra. The spring constant c_{GEW} of transmission input shaft 66 is thus in particular the one, which is effective, when transmission input shaft 66 is torsion loaded about its central longitudinal axis.

When transmitting a torque through first component 46, a first mass moment of inertia J₁ counteracts the torque transferred through first component 46. When transmitting a torque through third component 62, a second mass moment of inertia J₂ acts against a change of the torque transmitted through third component 62.

In the embodiments shown in FIGS. 2 through 4, it is respectively provided that motor vehicle drive train 2, or torque converter device 1, or torsion vibration damper 10 are configured, so that the quotient which is formed on the one hand from the sum (c₁+c₂) of the spring constant c₁ of first energy accumulator means 38 [in the units of Nm/rad] and the spring constant c₂ of second energy accumulator means 40 [in the units of Nm/rad] and on the other hand of the first mass moment of inertia J₁ [in the units of kg*m²], is greater than or equal to 17765 N*m/(rad*kg*m²) and less than or equal to 111033 N*m/(rad*kg*m²). Thus, put into an equation, the following applies:

17765 N*m/(rad*kg*m²)≦(c₁+c₂)/J₁≦111033 N*m/(rad*kg*m²),

wherein c₁ is the spring constant of first energy accumulator means 38 [in the units of Nm/rad] and wherein c₂ is the spring constant of second energy accumulator means 40 [in the units of Nm/rad] and wherein J₁ is the first mass moment of inertia [in the units of kg*m²]. The values or ranges however can be set in a manner as it is described supra and infra.

In the embodiments shown in the FIGS. 2 through 4, it is furthermore respectively provided that motor vehicle drive train 2, or torque converter device 1 or torsion vibration damper 10 are configured, so that the quotient, which is formed on the one hand from the sum (c₁+c_{GEW}) of the spring constant c₂ of second energy accumulator means 40 [in the units of Nm/rad] and the spring constant c_{GEW} of transmission input shaft 66 [in the units of Nm/rad] and on the other hand of the second mass moment of inertia J₂ [in the units of kg*m²], is greater than or equal to 3158273 N*m/(rad*kg*m²) and less than or equal to 12633094 N*m/(rad*kg*m²). Thus, put into an equation, the following applies: 3158273 N*m/(rad*kg*m²)≦(c₂+c_{GEW})/J₂≦12633094 N*m/(rad*kg*m²), wherein c₂ is the spring constant of second energy accumulator means 40 [in the units of Nm/rad] and wherein c_{GEW} is the spring constant of transmission input shaft 66 [in the units of Nm/rad], and wherein J₂ is the second mass moment of inertia [in the units of kg*m²]. The values or ranges however, can be comprised in a manner as it is described supra and infra.

In the embodiments shown in FIGS. 2 through 4 in particular, it can be provide that the first mass moment of inertia J₁ is substantially comprised of the mass moments of inertia of the following components: outer turbine dish 26 with extension 32, inner turbine dish 262, turbine blades or blading of the turbine or of turbine shell 24, driver component 50 with housing 82 and housing cover 264, first component 46, first connection means 52 or 54, second connection means 56, slider dish(es) 94 or roller shoes 82, possibly a portion of arc springs 42, possibly a portion of compression springs 44, possibly a portion of the oil, or oil, which is included in the arc spring channel(s), and possibly a portion of the oil, or oil with reference to the turbines, or oil, which is in the turbine. The mass moments of inertia thus particularly relate to rotation axis 36.

Furthermore it can be provided in the embodiments shown in FIGS. 2 through 4, that the second mass moment of inertia J₂ is substantially comprised of the mass moments of inertia of the following components: flange or third component 62, hub 64, which furthermore can also be integrally provided with flange 62, and possibly a portion of transmission input shaft 66 and possibly a portion of compression springs 44 and possibly a non-illustrated diaphragm spring for a controlled hysteresis, and possibly shaft retaining rings and/or seal elements.

FIG. 5 shows a spring/rotating mass schematic of a component of an exemplary motor vehicle drive train 2 according to the invention, or of the embodiment shown in FIG. 1, comprising a configuration shown in FIG. 2 or 3, or shown in FIG. 4 in case the converter lockup clutch is closed.

The system can be considered in particular in an ideal manner as a series connection comprising first engine side rotating mass 266, clutch 268, second rotating mass 270, connected at the input side of first spring 272 between clutch 268, first spring 272, third rotating mass 274, connected between first spring 272 and second spring 276, second spring 276, fourth rotating mass 278, connected between second spring 276 and third spring 280, and third spring 280.

The section formed by the series connection of first spring 272, third rotating mass 274, second spring 276, fourth rotating mass 278 and third spring 280 thus forms from an ideal point of view a spring/rotating mass diagram for first energy accumulator means 38, the connection of first energy accumulator means 38 and second energy accumulator means 40, second energy accumulator means 40, the connection of second energy accumulator means 40 to transmission input shaft 66 and transmission input shaft 66.

Subsequently, an exemplary improvement of the exemplary embodiments, advantages and effects according to the invention described supra based on the figures, shall be described, which can be provided at least in an improved embodiment of the invention.

Quite frequently good or optimum insulation properties will be required, when the lockup clutch is completely closed in order to reach a lower or minimum fuel consumption or CO₂ output. It can thus be desirable that the goal is accomplished within a predetermined partial load range, in which the combustion engine is mostly operated. The insulation required for good sound and vibration comfort can be additionally accomplished under high loads, which do not occur that often and under full load, by means of an additional slipping lockup clutch.

Torque converter device 1 or torque converter 1 comprising torsion vibration damper or energy accumulator devices 38 or 40, respectively, constitutes a torsion vibration system in combination with engine 250 and drive train 2 of the vehicle. The natural modes of the torsion vibration system are induced due to the variations of the rotation of combustion engine 250. Each natural mode of the system comprises an associated natural frequency. When said natural frequency coincides with the frequency of rotation of the combustion engine 250, the system vibrates in resonance, this means at maximum amplitude. It is often useful to avoid high amplitudes, since they can cause disturbing vibrations and noises. The natural frequencies of the system depend on the torsion stiffnesses and rotating masses in the system. Therefore, the major components are in particular configured, so that between torsion dampers or energy accumulator means 38 or 40, respectively, a large mass is created, or a large mass moment of inertia. On the other hand the major components between the lockup clutch and the torsion vibration damper, and those between torsion vibration damper and transmission input shaft are configured, so that the smallest masses possible are created in this location. The natural frequencies of the system are thereby excited to a lesser extent in the operating range of combustion engine 250. The insulation due to the support of the damper is performed between the primary side and the secondary side (=>turbine against the increased mass moment of inertia).

Through the arrangement of the double damper or of the torsion vibration damper, an improved insulation is accomplished at low speeds, when the clutch is closed through the low to medium stiffnesses of the outward positioned damper, or of the first energy accumulator means and of the inner damper, connected in series, or of the second energy accumulator means.

At higher speeds, increased friction can lead to an increased stiffness of the outer damper or of first energy accumulator means 38. Herein, the inner damper connected in series, or second energy accumulator means 40 (in particular without friction), leads to more advantageous vibration characteristics in the upper speed range.

A significant improvement of the double damper or of the torsion vibration damper is performed by the configuration of a torsion vibration damper or an energy accumulator means especially for partial load operation (lower torque), so that a very low spring stiffness of the torsion vibration damper or of the energy accumulator means can be realized in the range. Hereby, the reactive forces between the elastic element and the housing (dish) become smaller, furthermore, the mass of the spring element is smaller and thereby generates less centrifugal force and less friction relative to the housing (dish). This improves insulation. Through this measure, controlled two-mass inertia characteristics of the converter housing relative to the turbine are achieved.

Through the use of a sliding support or roller body support (slider shoe/ball screw shoe or roller shoe), the friction of the exterior elastic element, or of first energy accumulators 42 over the complete speed range is reduced. Thereby an additional improvement of the insulation is accomplished in combination with the inner damper connected in series and second energy accumulator means 40.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### DESIGNATIONS

1 hydrodynamic torque converter device
2 motor vehicle drive train
10 torsion vibration damper
12 converter torus
14 converter lockup clutch
16 converter housing
18 drive shaft like engine output shaft of a combustion engine
20 pump or pump shell
22 stator shell
24 turbine or turbine shell
26 outer turbine shell
28 torus interior
30 wall section of 26
32 extension at 30 of 26
34 straight section of 32 or annular disk shaped section of 32
36 rotation axis of 10
38 first energy accumulator means
40 second energy accumulator means
42 first energy accumulator
44 second energy accumulator
46 first component of 10
48 load transfer path
50 driver component
52 connection means or welded connection between 32 and 50 in 48
54 connection means or bolt or rivet connection between 32 and 50 in 48
56 connection means or bolt or rivet connection between 50 and 46 in 48
60 second component
62 third component
64 hub
66 output shaft, transmission input shaft
68 support section
72 first disk carrier of 14
74 first disk of 14
76 second disk carrier of 14
78 second disk of 14
79 disk packet of 14
80 piston for actuating 14
81 friction liner of 14
82 housing
84 roller shoe
86 lug
88 non-free end of 82
90 free end of 82
92 second rotation angle limiter means 92 of 40
94 slider shoe
250 combustion engine, six-cylinder engine
252 cylinder of 250
254 transmission
256 transmission output shaft
258 differential
260 drive axle
262 inner turbine dish
264 cover
266 engine side rotating mass, first rotating mass
268 clutch
270 rotating mass of the connection, second rotating mass
272 first spring
274 rotating mass of the connection between 272 and 276, third rotating mass
276 second spring
278 rotating mass of the connection between 276 and 280, fourth rotating mass
280 third spring

1-7. (canceled)

8. A motor vehicle drive train comprising:
a six-cylinder combustion engine comprising a maximum engine torque M_{mot,max};
an engine output shaft or a crank shaft;
a transmission input shaft;
a torque converter device comprising a converter housing, a converter lockup clutch, a torsion vibration damper and a converter torus, wherein said converter housing is non-rotatably coupled to said engine output shaft or crank shaft, said converter torus is formed by a pump shell, a turbine shell and a stator shell;
said torsion vibration damper comprises a first energy accumulator means, a second energy accumulator means and a first component, wherein said first energy accumulator means comprises at least one first energy accumulator and said second energy accumulator means comprises at least one second energy accumulator, said first energy accumulator means connected in series with said second energy accumulator means, said first component is arranged between and connected in series with said first and second energy accumulator means, and said turbine shell comprises an outer turbine shell non-rotatably connected to said first component;
wherein said torque converter device further comprises a third component non-rotatably coupled to said transmission input shaft, which in particular adjoins the torque converter device, and said third component is connected in series with said second energy accumulator means and said transmission input shaft, so that a torque can be transferred from said second energy accumulator means through said third component to said transmission input shaft;
wherein during a torque transfer through said first component, a change of said torque transferred through said first component is counteracted by a first mass moment of inertia J₁, and during a torque transfer through said third component, a change of said torque transferred through said third component is counteracted by a second mass moment of inertia J₂;
wherein a spring constant c₁ [in the units of Nm/°] of said first energy accumulator means is greater than or equal to a product of said maximum engine torque M_{mot,max} [in the units of Nm] of said six-cylinder combustion engine and a factor 0.014 [in the units of 1/°] and less than or equal to a product of said maximum engine torque M_{mot,max} [in the units of Nm] of said six-cylinder combustion engine and a factor 0.068 [in the units of 1/°];
wherein a spring constant c₂ [in the units of Nm/°] of said second energy accumulator means is greater than or equal to a product of said maximum engine torque M_{mot,max} [in the units of Nm] of said six-cylinder combustion engine and a factor 0.035 [in the units of 1/°] and less than or equal to a product of said maximum engine torque M_{mot,max} [in the units of Nm] of said six-cylinder combustion engine and a factor 0.158 [in the units of 1/°];
wherein a quotient formed from a sum of said spring constant c₁ [in the units of Nm/rad] of said first energy accumulator means and said spring constant c₂ [in the units of Nm/rad] of said second energy accumulator means divided by said first mass moment of inertia J₁ [in the units of kg*m²] is greater than or equal to 17765 N*m/(rad*kg*m²) and less than or equal to 111033 N*m/(rad*kg*m²); and,
wherein a quotient formed from a sum of said spring constant c₂ [in the units of 1/rad] of said second energy accumulator means and a spring constant c_{GEW} [in the units of 1/rad] of said transmission input shaft divided by said second mass moment of inertia J₂ [in the units of kg*m²] is greater than or equal to 3158273 N*m/(rad*kg*m²) and less than or equal to 12633094 N*m/(rad*kg*m²).

9. The motor vehicle drive train according to claim 8, wherein said spring constant c_{GEW} of said transmission input shaft ranges from 100 Nm/° to 350 NM/°.

10. The motor vehicle drive train according to claim 8, wherein said first energy accumulator means comprises a plurality of first energy accumulators, said plurality of first energy accumulators offset circumferentially relative to a circumferential direction of a rotation axis of said torsion vibration damper and connected in parallel.

11. The motor vehicle drive train according to claim 8, wherein said at least one first energy accumulator is a coil spring or an arc spring.

12. The motor vehicle drive train according to claim 8, wherein said second energy accumulator means comprises a plurality of second energy accumulators, said plurality of second energy accumulators offset circumferentially relative to a circumferential direction of a rotation axis of said torsion vibration damper and connected in parallel.

13. The motor vehicle drive train according claim 8, wherein said at least one second energy accumulators is a coil spring, a straight spring or a compression spring.

14. A motor vehicle drive train comprising:
a six-cylinder combustion engine comprising a maximum engine torque M_{mot,max};
a torque converter device comprising a converter lockup clutch having a piston, a torsion vibration damper and a converter torus, wherein said converter torus is formed by a pump shell, a turbine shell and a stator shell;
said torsion vibration damper comprises a first energy accumulator means, a second energy accumulator means and a first component, said first energy accumulator means comprises at least one first energy accumulator and said second energy accumulator means comprises at least one second energy accumulator, said first energy accumulator means connected in series with said second energy accumulator means, said first component is arranged between and connected in series with said first and second energy accumulator means, wherein said turbine shell comprises an outer turbine dish, said outer turbine dish is non-rotatably connected to said first component through a driver component, said first component and/or said driver component is configured with a substantially thicker wall than said piston and/or a substantially stiffer wall than said piston arranged to form an additional mass or to form a large mass moment of inertia J₁, acting between said first and second energy accumulator means, and arranged for torque transfer through said first component and/or through said driver component.

15. The motor vehicle drive train according to claim 14 wherein said first component is a plate.

16. The motor vehicle drive train according to claim 14 wherein said driver component is a plate.

17. The motor vehicle drive train according to claim 14 wherein said substantially thicker wall is at least twice as thick, at least three times as thick, at least five times as thick, at least ten times as thick or at least twenty times as thick as said piston.

18. The motor vehicle drive train according to claim 14 wherein said substantially stiffer wall is at least twice as stiff, at least three times as stiff, at least five times as stiff, at least ten times as stiff or at least twenty times as stiff as said piston.
